(19) United States
(12) Patent Application Publication
(10) Pub. No.: US 2014/0366273 A1
(43) Pub. Date: Dec. 18, 2014

(54) Pillow with Integrated Alarm System

(71) Applicants: Trent Wilkins Davis, II, Salina, KS (US); Pamela Davis, Salina, KS (US)

(72) Inventors: Trent Wilkins Davis, II, Salina, KS (US); Pamela Davis, Salina, KS (US)

(21) Appl. No.: 14/302,856

(22) Filed: Jun. 12, 2014

Related U.S. Application Data
(60) Provisional application No. 61/834,154, filed on Jun. 12, 2013.

(51) Int. Cl. A47G 9/10; G04G 13/02

(52) U.S. Cl. CPC A47G 9/10; G04G 13/02; A47G 2009/006
USPC 5/639

(57) ABSTRACT

Described is a pillow having an integrated alarm system that is wirelessly operable using an external electronic device, such as a smartphone, tablet computer, or other similar electronic devices. The pillow has a soft, cushioned body, preferably composed of foam, and the pillow has an interior cavity in which an alarm system is positioned. The exterior surface of the pillow body includes a stretchable band thereon to help the user to hold the pillow. Further, the pillow can be disposed within a removable cover that protects the pillow body from stains or damage. The alarm system includes a speaker for producing a tone or playing music to wake a user and a vibrating motor to silently wake the user without disturbing others. The user can select the time of the alarm and the type of the alarm remotely using the external electronic device.

### CROSS REFERENCE TO RELATED APPLICATION

This application claims the benefit of U.S. Provisional Application No. 61/834,154 filed on Jun. 12, 2013, entitled “Power Nap Pillow.” The above identified patent application is herein incorporated by reference in its entirety to provide continuity of disclosure.

### BACKGROUND OF THE INVENTION

1. Field of the Invention

The present invention relates to pillow having a built-in alarm system. More specifically, the present invention provides a pillow having an alarm system comprising a speaker and vibrating motor in order to wake a user after a pre-set period of time has expired, or at a certain time. Preferably, the alarm system is wirelessly operable using an external electronic device, such as a cell phone or tablet computer. In this way, the user can use the pillow of the present invention as a comfortable resting surface regardless of his or her location, and can use the alarm system to ensure that he or she does not oversleep.

Many people do not get sufficient sleep at night for various reasons. Some people have irregular work schedules and work nights shifts, or wake up early in the morning to go to work, preventing them from obtaining a full night's rest. Further, some people have difficulty sleeping throughout the night and may not feel well rested in the morning. As a result, people may feel tired throughout the day and may take a nap to compensate for the insufficient sleep during the previous night. Taking a nap allows the person to gain additional rest so as to have more energy for the remainder of the day.

However, people often nap for too long, causing them to miss a particular event or perform a particular task. For example, people may take a nap on a train or bus which could cause the person to miss their stop. Further, students may nap between classes and may oversleep, causing them to miss class. People often fail to set their alarm clock when taking a nap, and many people do not have access to an alarm clock throughout the day. Thus, if a person wishes to take a nap away from their home, the person may have no way to monitor how long the person is napping.

Additionally, many people desire to take a nap when away from home, but do not have a pillow readily available. Finding a comfortable surface on which a user may rest his or her head can be difficult in public areas. Full-sized bed pillows are too large to travel with, and are thus inconvenient to transport during the day. Thus, a portable pillow that has a built-in alarm system is desired to allow users to take naps throughout the day while having a means for waking the user after a predetermined period of time.

The present invention provides a pillow having an integrated alarm system. The pillow of the present invention comprises a pillow having a soft, cushioned body, a stretchable band thereon for holding the pillow, and an interior cavity in which an alarm system is contained. The pillow body is enclosed within a removable cover that protects the pillow body from spills and stains. The interior cavity houses an alarm system having an alarm, one or more speakers, a vibrating motor, and one or more batteries. The alarm system may be wirelessly operated via an external electronic device, such as a cell phone or tablet computer. Thus, the user can remotely set the alarm time and alert type using his or her cell phone, tablet computer, or other similar electronic device. In this way, the present invention provides a user with a pillow having an integrated alarm system so as to provide the user with a comfortable resting surface that includes a means to wake himself or herself at a particular time.

2. Description of the Prior Art

Devices have been disclosed in the prior art that relate to pillows having alarm systems. These include devices that have been patented and published in patent application publications. These devices generally relate to pillows having alarm systems that are removably positioned within the pillow. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 6,236,621 to Schettino discloses a pillow alarm device comprising a pillow with an interior compartment in which an alarm clock and a vibrating motor is positioned. The compartment includes a cover flap pivotally coupled thereto to provide access to the compartment. The alarm clock includes a display for displaying the time and the alarm time. The device further includes a battery power source. While Schettino discloses a pillow having an alarm system, Schettino fails to disclose a pillow having an integrated alarm system that is wirelessly operable using an external electronic device, such as a cell phone or tablet computer. Further, the device of Schettino is not adapted to sound an alarm after a predetermined period of time, and instead a user must input a particular time for the alarm to sound.

U.S. Pat. No. 6,044,161 to Lee discloses a pillow speaker that is adapted to transmit sounds and that serves as a resting surface for a user. The device includes a pillow headrest with an upper surface suited for receiving a user's head and a lower body portion. A pair of speakers is mounted through the upper surface and within the lower body portion. The lower body portion further includes a plurality of voids through which sound waves can travel. Thus, Lee discloses a pillow having speakers for playing sound or music, and fails to disclose a pillow having an integrated alarm system for waking the user after a predetermined period of time.

U.S. Pat. No. 7,461,422 to Baker discloses an alarm pillow comprising a pillow with an opening at an end thereof that provides access to a cavity. A portable electronic alarm can be removably positioned within the cavity through the opening. The alarm device comprises a planar top surface with a user interface thereon and bottom surface that is parallel to the top surface. Thus, Baker discloses a pillow having a removable alarm device that can be inserted into a cavity within the pillow. Baker fails to disclose a pillow having an integrated alarm system comprising a speaker and a vibrating motor.

U.S. Pat. No. 7,484,255 to Ho discloses a pillow having a sliding track installed between an upper cover and a lower cover with a bearing placed therein and slideable on the track. The device further includes a control panel comprising a circuit board connected to a motor, a microswitch, an audio sensor, a trumpet and a vibrator. The microswitch is connected to a touch panel for operation by a user. The control panel includes alarm modes for emitting alarm sounds, generating vibrations, or both. The audio sensor is adapted to sense whether a person is snoring, in which case the motor is rotated so that the upper cover moves slightly in an attempt to prevent the user from snoring. Thus, Ho discloses a pillow having various functions for stopping snoring and for providing an alarm. However, Ho fails to disclose a pillow having an interior cavity in which an alarm system is positioned, wherein the alarm system is wirelessly operable using an external electronic device, such as a cell phone or tablet computer.

U.S. Pat. No. 6,081,949 to Delicia discloses a pillow having an alarm system therein. The device includes a front panel secured to a back panel about the perimeter thereof, wherein the interior portion is filled with padded material. Further, an alarm clock is positioned within the interior portion along with a plurality of pressure sensors. Each sensor is operably connected to the alarm system such that when pressure is lifted from the pillow, the alarm will be deactivated. The alarm system has a display for showing the alarm activation time and includes a plurality of function buttons. The alarm can be accessed through a zippered opening on the pillow. Thus, Delicia discloses a pillow device having an alarm clock that must be inserted or removed from the pillow in order for user to operate the same. In this regard, Delicia fails to disclose an alarm system that is remotely operated.

Finally, U.S. Patent Application Publication Number 2013/0043988 to Bruno discloses a pillowcase alarm system having a pillowcase with a printed circuit board connected to a microcontroller and a vibration motor, wherein the pillowcase can wirelessly communicate with a computer or smartphone. The components are located within the pillowcase and are housed within a padded lining so as to retain the comfort of the pillow. The user can use the smartphone or computer to configure the alarm settings of the device. Thus, Bruno discloses a pillowcase having an alarm system rather than a pillow.

These prior art devices have several known drawbacks. Several devices in the prior art disclose pillows having removable alarm clocks or alarm systems. Thus, the user is required to set a conventional alarm clock and then position the alarm clock within an interior cavity of the pillow. The user may lose the alarm clock since it is a separate device from the pillow, or may simply forget to set the alarm clock. Further, a user may simply desire to sleep for a particular period of time, rather than set an alarm clock to sound an alarm at a particular time. Further, prior art alarm pillows do not allow the user to set the alarm system using a mobile phone or other similar device. Setting an alarm and the type of alarm using a smartphone or similar device may be more convenient for the user, and does not require the user to remove an alarm from the alarm pillow.

In light of the devices disclosed in the prior art, it is submitted that the present invention substantially diverges in design elements from the prior art and consequently it is clear that there is a need in the art for an improvement to existing alarm pillow devices. In this regard the instant invention substantially fulfills these needs.

### SUMMARY OF THE INVENTION

In view of the foregoing disadvantages inherent in the known types of alarm pillows now present in the prior art, the present invention provides a new pillow with an integrated alarm system wherein the same can be utilized for providing convenience for the user when taking a nap.

It is therefore an object of the present invention to provide a new and improved alarm pillow device that has all of the advantages of the prior art and none of the disadvantages.

It is another object of the present invention to provide a pillow having an integrated alarm system that allows users to remotely select the time of the alarm and the type of alert using an external electronic device, such as a smartphone or a tablet computer.

Another object of the present invention is to provide a pillow having an integrated alarm system that combines an alarm system and a pillow for the convenience of the user.

Yet another object of the present invention is to provide a pillow having an integrated alarm system with internally positioned speakers for playing music or producing a sound in order to wake the user, without disturbing others in the vicinity of the user.

Another object of the present invention is to provide a pillow having an imbedded vibrating motor to vibrate the pillow in order to wake the user, without disturbing others in the vicinity of the user.

A further object of the present invention is to provide a pillow having an integrated alarm system with a stretchable band thereon to assist the user in positioning the pillow in a desired orientation.

Another object of the present invention is to provide a pillow having an integrated alarm system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the pillow of the present invention.

FIG. 2 shows a schematic diagram of an embodiment of the pillow of the present invention.

FIG. 3 shows a schematic diagram of an embodiment of the pillow of the present invention having wireless capabilities.

FIG. 4 shows a view of a graphical user interface for controlling the alarm system of the present invention.

FIG. 5 shows a flowchart of the operation of the present invention.

### DETAILED DESCRIPTION OF THE INVENTION

Reference is made herein to the attached drawings. Like reference numerals are used throughout the drawings to depict like or similar elements of the pillow having an integrated alarm system of the present invention. For the purposes of presenting a brief and clear description of the present invention, the preferred embodiment will be discussed as used for providing a comfortable resting surface on which a user may position his or her head while also providing an alarm system to wake the user after a preset amount of time expires. The figures are intended for representative purposes only and should not be considered to be limiting in any respect.

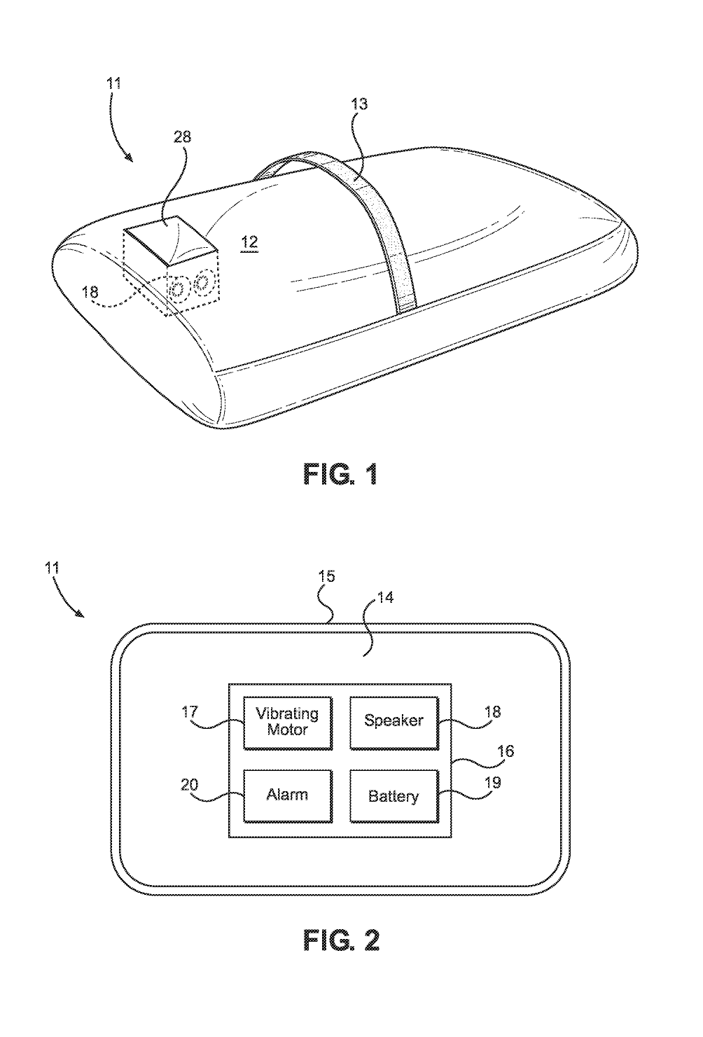

Referring now to FIG. 1, there is shown a perspective view of the pillow having an integrated alarm system of the present invention. The pillow 11 provides a user with a soft, comfortable surface on which the user may rest his or her head. The pillow 11 is preferably substantially rectangular, but may have any of a variety of shapes. The pillow 11 is preferably composed of foam, but may be composed of other soft materials including cotton, polyester, or down. In some embodiments of the present invention, the pillow 11 includes a stretchable band 13 on a rear surface 12 thereof. The stretchable band 13 helps to secure a user's hand or arm to the pillow 11 so as to help the user to hold the pillow 11 in a desired position.

The pillow 11 further comprises an alarm system disposed within an interior cavity thereof. The alarm system of the present invention comprises an alarm capable of generating a sound, a vibrating motor, and one or more speakers 18 that are preferably positioned internally within said body of said pillow 11. The speakers 18 are positioned internally so that the speakers 18 can be easily heard by a user having his or her head positioned on the pillow, but so that others in the vicinity of the user cannot easily hear the alarm. This helps to prevent the user from disturbing others when the alarm of the present invention sounds. Similarly, the vibrating motor is adapted to cause the body of the pillow to vibrate, silently waking the user without disturbing others in the nearby area.

The alarm system is battery operated, and can be powered using one or more disposable or rechargeable batteries. The batteries can be inserted and removed from the pillow 11 by means of a hinged lid 28 disposed on the rear surface 12 of the pillow 11 that provides access to a battery compartment. In some embodiments, the hinged lid 28 comprises a layer of padding or cushioning thereon, so that the user of the pillow 11 does not feel the hinged lid 28 on the exterior of the pillow 11.

Referring now to FIG. 2, there is shown a schematic diagram of an embodiment of the pillow of the present invention. The pillow 11 of the present invention comprises a body 14 composed of foam or other soft, plush material. The body 14 includes an interior cavity 16 in which the alarm system is positioned. The interior cavity 16 is preferably located subjacent to the rear surface of the pillow, so that the user can access the batteries 19 for insertion or removal. The alarm system comprises an alarm, one or more speakers 18, and a vibrating motor 17, wherein the components are operably connected by a control circuit.

In some embodiments of the present invention, the alarm system is inaccessible by the user so that the user cannot access the alarm, vibrating motor, or speakers. However, the batteries are accessible so that batteries can be inserted and removed from the pillow. In some embodiments of the present invention, the alarm system 20 is operated by a control panel disposed on the pillow. In such embodiments, the control panel comprises a display screen and one or more controls, such as switches or buttons, to set the time and the type of alarm. The control panel allows a user to input a specific time for the alarm to sound, or allows the user to set a timer such that the alarm sounds after a preset period of time. For example, the user can set the alarm to produce an alert after twenty minutes. This helps the user to nap for a particular period of time, which may be preferable to selecting the time at which the user will wake up. Further, the user can select the alert type and can choose to be woken by a beep or tone, music, vibrations, or a combination of these alerts. In this way, the control panel is attached to the pillow and allows a user to set an alarm and turn off the alarm once the user has woken up.

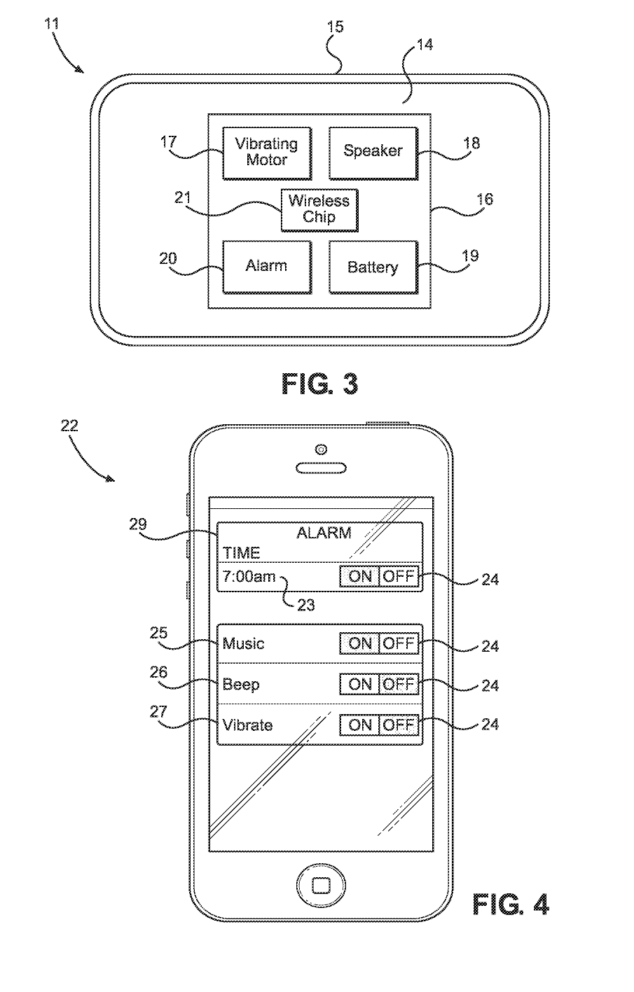

Referring now to FIG. 3, there is shown a schematic diagram of an embodiment of the pillow of the present invention having wireless capabilities. In the illustrated embodiment, the pillow 11 includes an interior cavity 16 having an alarm system powered by batteries 19, and further including an alarm 20, one or more speakers 18, a vibrating motor 17, and a control circuit, similar to the embodiment shown in FIG. 2. However, the illustrated embodiment further comprises a wireless chip 21 as well as its related components that allows the alarm system to communicate with an external electronic device.

In the illustrated embodiment, the user can operate the alarm system using an associated software application on an external electronic device, including but not limited to, a smartphone, a tablet computer, or a laptop. Thus, by using the software application, the user can easily set an alarm on the pillow of the present invention and turn off the alarm using his or her smartphone or similar device. Thus, in embodiments of the present invention having a wireless chip, the alarm system of the pillow can be remotely operated, obviating the need for a control panel to be disposed directly on the body of the pillow.

Referring now to FIG. 4, there is shown a graphical user interface for controlling the alarm system of the present invention. The pillow can be operated using an associated software application on a smartphone 22 or other similar device. In this way, the smartphone can be paired to the pillow of the present invention. The software application includes a graphical user interface (GUI) 29. The GUI displays, and allows the user to set, the alarm time 23. Further, the GUI includes on/off switches 24 for turning the alarm 23 on or off. The GUI 29 also provides the user with options for the alert type, including a musical alert 25, a beep or tone 26 similar to conventional alarm clocks, or a vibration 27 or a pattern of vibrations. Again, the user can select to turn the various alert types on or off 24. Thus, the user can be woken by one or more of the various alert types.

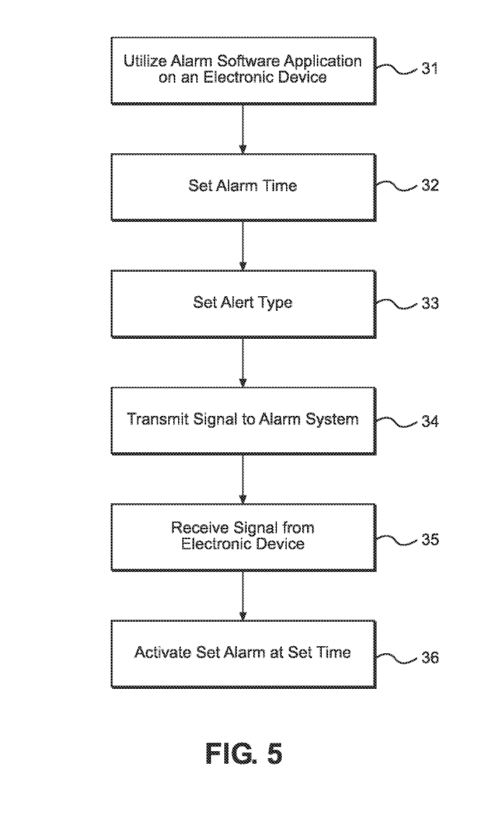

Referring now to FIG. 5, there is shown a flowchart of the operation of the present invention. In operation, a user can utilize the pillow of the present invention by utilizing an associated software application on an external electronic device 31, such as a smartphone or tablet computer. Using the graphical user interface of the software application, the user can set an alarm time 32 and the type of alert 33. The external electronic device then transmits a signal 34 to the alarm system of the pillow of the present invention, and the wireless chip of the alarm system receives the signal 35. The alarm system of the pillow then activates the alert type selected at the alarm time selected 36 by the user on the graphical user interface. When the alarm sounds, the user can turn off the alarm using the GUI on the software application.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pillow having an integrated alarm system, comprising:
a pillow having a cushioned body with an interior cavity in which an alarm system comprising an alarm, one or more speakers, a vibrating motor, and one or more batteries are positioned;
wherein said alarm can be set to produce an alert at a particular time or upon expiration of a preset period of time.

2) The pillow of claim 1, wherein said alert comprises one or more of a vibration, an audible tone, or music.

3) The pillow of claim 1, wherein said pillow further comprises a front surface on which a user may position his or her head, and a back surface on which a stretchable band is positioned.

4) The pillow of claim 1, wherein said cushioned body comprises foam.

5) The pillow of claim 1, wherein said alarm system further comprises a wireless chip, wherein a user can pair an external electronic device to said alarm system in order to operate said alarm system remotely using said external electronic device.

6) The pillow of claim 5, wherein said external electronic device is any one of a cell phone, a tablet computer, or a laptop.

7) The pillow of claim 1, further comprising:
a control panel disposed on a surface of said pillow and operably connected to said alarm system, wherein said control panel comprises controls for setting an alarm for a particular time, for selecting an alert type, and for turning an alarm on or off.

8) The pillow of claim 1, wherein said one or more batteries are accessible by means of a hinged lid disposed on a rear surface of said pillow.
